(19) United States
(12) Patent Application Publication
(10) Pub. No.: US 2025/0138603 A1
(43) Pub. Date: May 1, 2025

(54) DISPLAY DEVICE

(71) Applicant: Samsung Display Co., LTD., Yongin-si (KR)

(72) Inventors: YOUNHWAN JUNG, Yongin-si (KR); SANG WOL LEE, Yongin-si (KR); YOONKI HONG, Yongin-si (KR)

(21) Appl. No.: 18/916,399

(22) Filed: Oct. 15, 2024

(30) Foreign Application Priority Data
Oct. 26, 2023 (KR) 10-2023-0144876

(51) Int. Cl. G06F 1/18; G06F 1/16; G06F 1/20

(52) U.S. Cl. CPC G06F 1/184; G06F 1/163; G06F 1/1637; G06F 1/203

(57) ABSTRACT

A display device includes a display panel including a display portion and a bending portion adjacent to the display portion, a circuit board spaced apart from the display portion in a first direction and connected to the bending portion, and a shape maintaining portion disposed between the display portion and the circuit board and including a first surface adjacent to the display portion and including a central portion convexly curved in a second direction opposite to the first direction and an edge portion which is flat and a second surface adjacent to the circuit board.

This application claims priority to Korean Patent Application No. 10-2023-0144876, filed on Oct. 26, 2023, and all the benefits accruing therefrom under 35 U.S.C. § 119, the content of which in its entirety is herein incorporated by reference.

### BACKGROUND

### 1. Field

Embodiments relate to a display device.

### 2. Description of the Related Art

A display device that displays an image to provide visual information to a user is provided in various shapes such as a circle, a polygon, or the like. Alternatively, the display device may have a shape in which each vertex of a polygon has a curvature.

The display device may have a multilayer structure including a plurality of layers having various functions. The plurality of layers may be combined with each other while maintaining a shape corresponding to the shape of the display device to form the display device.

### SUMMARY

Embodiments provide a display device with improved reliability.

A display device in an embodiment of the disclosure includes a display panel including a display portion and a bending portion adjacent to the display portion, a circuit board spaced apart from the display portion in a first direction and connected to the bending portion, and a shape maintaining portion disposed between the display portion and the circuit board and including a first surface adjacent to the display portion and including central portion convexly curved in a second direction opposite to the first direction and an edge portion which is flat and a second surface adjacent to the circuit board.

In an embodiment, the second surface may include an overlapping portion that overlaps the circuit board in a plan view, and a non-overlapping portion that does not overlap the circuit board in the plan view. The overlapping portion and the non-overlapping portion may have a step.

In an embodiment, the non-overlapping portion may protrude further in the first direction than the overlapping portion.

In an embodiment, the overlapping portion may be flat.

In an embodiment, an edge of the shape maintaining portion may include a curved portion extending in a circular shape in a plan view, and a straight portion extended to the curved portion and extending in a straight line in the plan view.

In an embodiment, the bending portion may cover the straight portion.

In an embodiment, the display portion may be disposed along a profile of the first surface of the shape maintaining portion, and the circuit board may be disposed along a profile of the second surface of the shape maintaining portion.

In an embodiment, the display device may further include a window disposed on the display panel. The window may have a dome shape that is convexly curved in the second direction.

In an embodiment, the window may accommodate the display panel, the circuit board, and the shape maintaining portion.

In an embodiment, the edge portion may have an inclination.

A display device in an embodiment of the disclosure includes a display panel including a display portion and a bending portion adjacent to the display portion, a circuit board spaced apart from the display portion in a first direction and connected to the bending portion, and a shape maintaining portion disposed between the display portion and the circuit board and including a first surface adjacent to the display portion, a second surface adjacent to the circuit board, and an edge including a curved portion extending in a circular shape in a plan view and a straight portion extended to the curved portion and extending in a straight line in the plan view.

In an embodiment, the bending portion may cover the straight portion.

In an embodiment, a central portion of the first surface may be convexly curved in a second direction opposite to the first direction, and an edge portion of the first surface may be flat.

In an embodiment, the second surface may include an overlapping portion that overlaps the circuit board in the plan view, and a non-overlapping portion that does not overlap the circuit board in the plan view. The overlapping portion and the non-overlapping portion may have a step.

In an embodiment, the non-overlapping portion may protrude further in the first direction than the overlapping portion.

In an embodiment, the overlapping portion may be flat.

In an embodiment, the display portion may be disposed along a profile of the first surface of the shape maintaining portion, and the circuit board may be disposed along a profile of the second surface of the shape maintaining portion.

In an embodiment, the display device may further include a window disposed on the display panel. The window may have a dome shape that is convexly curved in a second direction opposite to the first direction.

In an embodiment, the window may accommodate the display panel, the circuit board, and the shape maintaining portion.

In an embodiment, the edge portion may have an inclination.

In a display device in embodiments of the disclosure, the display device may include a shape maintaining portion including a first surface and a second surface having different cross-sectional shapes. A central portion of the first surface adjacent to a display portion of a display panel may be convexly curved, and the second surface adjacent to a circuit board may be flat. Accordingly, the display portion may be curved to correspond to a dome shape of a window, and the circuit board may be disposed flat. Since a shape of the circuit board may be maintained by the shape maintaining portion, damage to elements disposed on the circuit board may be prevented.

In addition, since an edge of the shape maintaining portion includes a straight portion extending in a straight line, interference of the shape maintaining portion with respect to a bending of a bending portion of the display panel may be prevented. In addition, since an edge portion of the first surface of the shape maintaining portion is flat, the shape maintaining portion may be easily manufactured.

### BRIEF DESCRIPTION OF THE DRAWINGS

The above and other exemplary embodiments, advantages and features of this disclosure will become more apparent by describing in further detail exemplary embodiments thereof with reference to the accompanying drawings, in which:

FIG. 1 is a plan view illustrating an embodiment of a display device according to the disclosure.

FIG. 2 is an exploded perspective view illustrating the display device of FIG. 1.

FIG. 3 is a cross-sectional view illustrating a window included in the display device of FIG. 1.

FIG. 4 is a plan view illustrating a display panel included in the display device of FIG. 1.

FIG. 5 is a cross-sectional view taken along line I-I′ of FIG. 1.

FIG. 6 is an enlarged cross-sectional view of area A of FIG. 5.

FIG. 7 is a perspective view illustrating an embodiment of a shape maintaining portion included in the display device of FIG. 1.

FIG. 8 is an enlarged perspective view of area B of FIG. 7.

FIG. 9 is a bottom view illustrating a state in which a display panel, a shape maintaining portion, and a circuit board included in the display device of FIG. 1 are coupled.

FIGS. 10 and 11 are perspective views illustrating another embodiment of a shape maintaining portion included in the display device of FIG. 1.

FIG. 12 is a perspective view illustrating another embodiment of FIG. 11.

FIG. 13 is a cross-sectional view illustrating another embodiment of a display device according to the disclosure.

### DETAILED DESCRIPTION

Hereinafter, embodiments of the disclosure will be described in more detail with reference to the accompanying drawings. The same reference numerals are used for the same components in the drawings, and redundant descriptions of the same components will be omitted.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

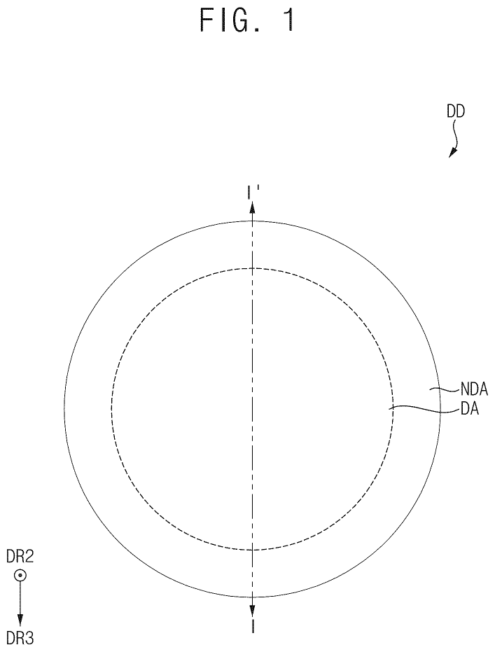

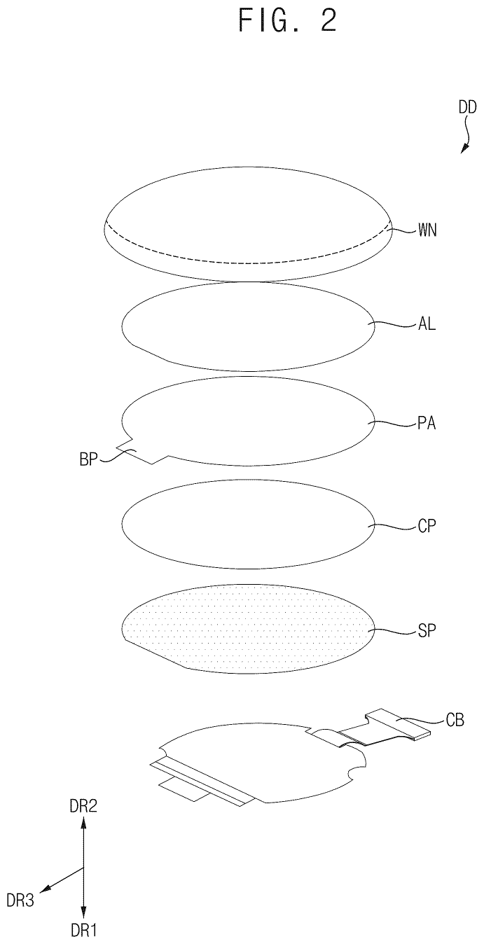

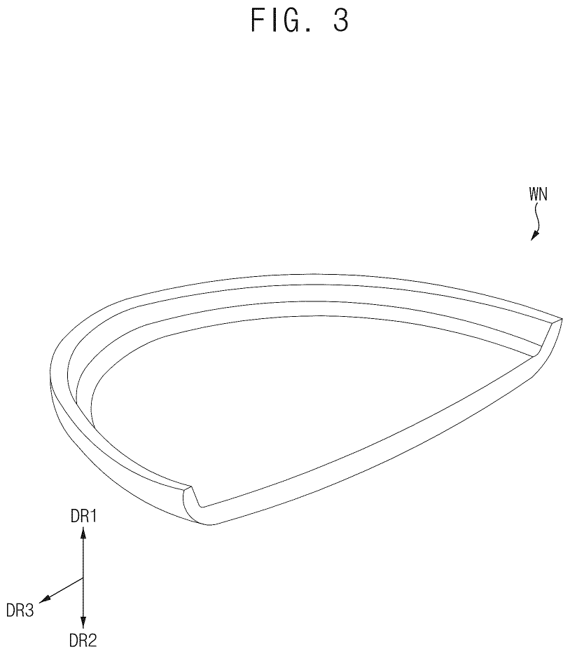

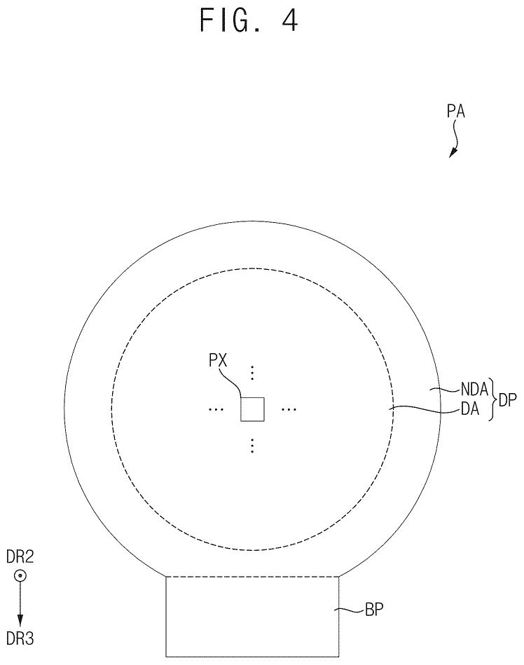

FIG. 1 is a plan view illustrating an embodiment of a display device according to the disclosure. FIG. 2 is an exploded perspective view illustrating the display device of FIG. 1. FIG. 3 is a cross-sectional view illustrating a window included in the display device of FIG. 1. FIG. 4 is a plan view illustrating a display panel included in the display device of FIG. 1.

Referring to FIGS. 1, 2, 3, and 4, a display device DD may include a window WN, an adhesive layer AL, a display panel PA, a cover panel CP, a shape maintaining portion SP, and a circuit board CB.

The shape maintaining portion SP, the cover panel CP, the display panel PA, the adhesive layer AL, and the window WN may be sequentially disposed on the circuit board CB. That is, the window WN, the adhesive layer AL, the display panel PA, the cover panel CP, the shape maintaining portion SP, and the circuit board CB may be sequentially disposed along a first direction DR1.

The window WN may protect components disposed below the window WN from external environment, impact, or the like. The window WN may be optically transparent. In an embodiment, the window WN may include glass, a transparent polymer material, or the like, for example.

In an embodiment, the window WN may have a dome shape. In an embodiment, the window WN may have a dome shape that is convexly curved in a second direction DR2, which is opposite to the first direction DR1, in a cross-sectional view, for example. Since the window WN has the dome shape, the window WN may define an inner space. The window WN may accommodate components disposed below the window WN in the inner space.

The adhesive layer AL may be disposed below the window WN. The adhesive layer AL may couple the window WN and a component disposed below the adhesive layer AL. The adhesive layer AL may be optically transparent. In an embodiment, the adhesive layer AL may be an optically clear adhesive (“OCA”), an optically clear resin (“OCR”), or a pressure sensitive adhesive (“PSA”), for example. Accordingly, influence of the adhesive layer AL on a visibility of an image generated in the display panel PA may be reduced.

The display panel PA may be disposed below the adhesive layer AL. In an embodiment, the display panel PA may be coupled to the window WN by the adhesive layer AL, for example.

The display panel PA may include a display portion DP and a bending portion BP. The display portion DP may include a display area DA and a non-display area NDA.

The display area DA may be an area that displays an image. A plurality of pixels PX may be disposed in the display area DA. Each of the pixels PX may be defined as a minimum light-emitting unit that displays light. In an embodiment, the pixels PX may be disposed in a matrix form in the display area DA, for example. In another embodiment, the pixels PX may be disposed in a matrix form at a central portion of the display area DA, and may be disposed in a stepwise manner at an edge portion of the display area DA, for example. However, the disclosure is not limited thereto, and the pixels PX may be disposed in various forms within a range for displaying an image in the display area DA.

Signal lines such as a gate line and a data line may be disposed in the display area DA. The signal lines may be connected to each of the pixels. Each of the pixels may receive a gate signal, a data signal, or the like from the signal lines. Accordingly, an image may be displayed in the second direction DR2 in the display area DA. The image displayed in the display area DA may be provided outside the display device DD. That is, the display area DA of the display panel PA may be defined as the display area DA of the display device DD.

In an embodiment, the display area DA may have a curvature. In an embodiment, the display area DA may have a circular shape having a constant curvature as a whole in a plan view, for example. However, the disclosure is not limited thereto, and the display area DA may have various shapes such as a polygonal planar shape, an elliptical planar shape, or the like.

The non-display area NDA may be an area that does not display an image. A driver that drives the pixels PX may be disposed in the non-display area NDA. The non-display area NDA may surround at least a portion of the display area DA. In an embodiment, the non-display area NDA may surround an entirety of the display area DA in a plan view, for example. The non-display area NDA may have a shape corresponding to a shape of the display area DA. In an embodiment, the display area DA may have a circular planar shape, and the non-display area NDA may have a straight-line shape in at least a partial area in a plan view, and may have a circular planar shape having the same curvature as the display area DA in an area other than the partial area, for example. However, the disclosure is not limited thereto, and the non-display area NDA may have various shapes such as a polygonal planar shape, an elliptical planar shape, or the like.

The bending portion BP may be adjacent to the display portion DP in a third direction DR3 intersecting each of the first direction DR1 and the second direction DR2. In an embodiment, the third direction DR3 may be perpendicular to each of the first direction DR1 and the second direction DR2, for example. The bending portion BP may be an area that does not display an image. The bending portion BP may be an area where the display panel PA is bent. The display panel PA may be bent so that at least a portion of the bending portion BP overlaps the display portion DP. Specifically, the display panel PA may be bent so that the bending portion BP is disposed on a rear surface of the display portion DP.

The cover panel CP may be disposed below the display panel PA. The cover panel CP may cover a lower surface of the display panel PA. The cover panel CP may have a single-layer structure or a multilayer structure. In an embodiment, the cover panel CP may have a structure in which a cushion member, a heat dissipation member, a conductive thin film, or the like are stacked, for example. The cushion member may absorb an impact applied to the display panel PA. The heat dissipation member may prevent heat applied to the display panel PA, or may diffuse heat generated from the display panel PA. The conductive thin film may offset electromagnetic interference applied to the display panel PA.

The shape maintaining portion SP may be disposed below the display panel PA. The shape maintaining portion SP may maintain a shape of a component disposed below the shape maintaining portion SP. A detailed description thereof will be described later.

The circuit board CB may be disposed below the shape maintaining portion SP. The circuit board CB may be connected to the bending portion BP of the display panel PA. That is, the bending portion BP of the display panel PA may be bent toward the first direction DR1 to be connected to the circuit board CB.

Various elements, such as a driver, a processor, or the like for driving the display panel PA, may be disposed on the circuit board CB. In an embodiment, the elements may be disposed on a first surface of the circuit board CB adjacent to the shape maintaining portion SP. In another embodiment, the elements may be disposed on a second surface of the circuit board CB spaced apart from the shape maintaining portion SP.

In an embodiment, the display device DD may be applied to a wearable device. In an embodiment, the display device DD may be applied to a watch-type device, for example. However, the disclosure is not limited thereto, and the display device DD may be applied to various electronic devices.

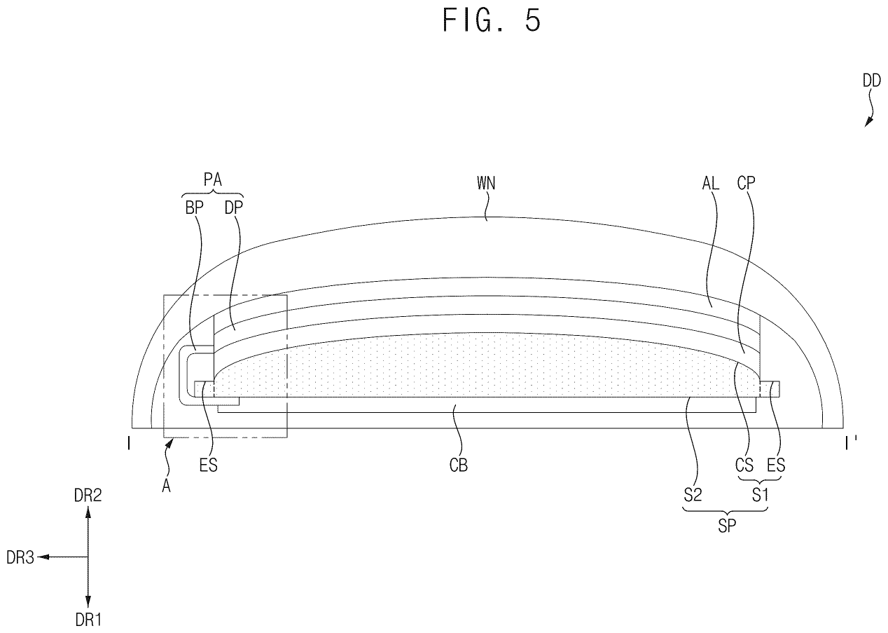

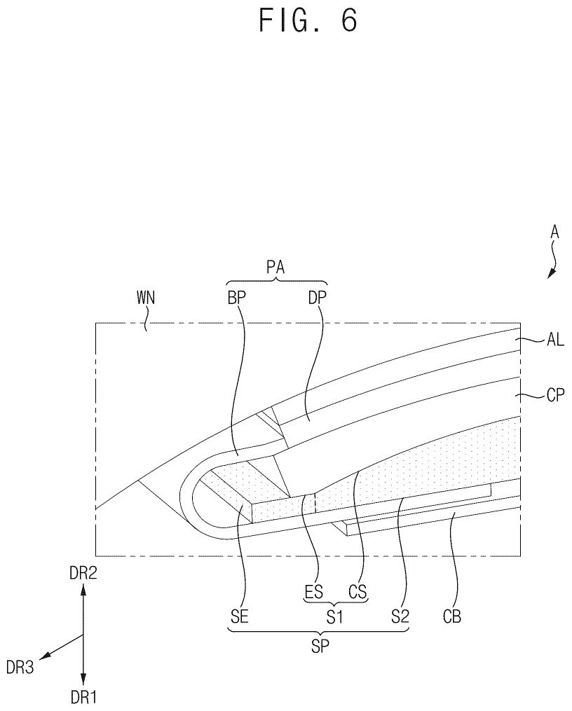

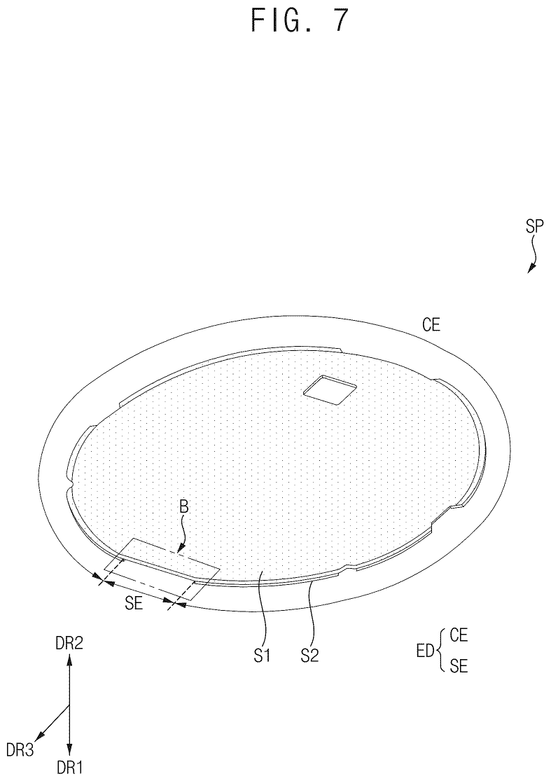

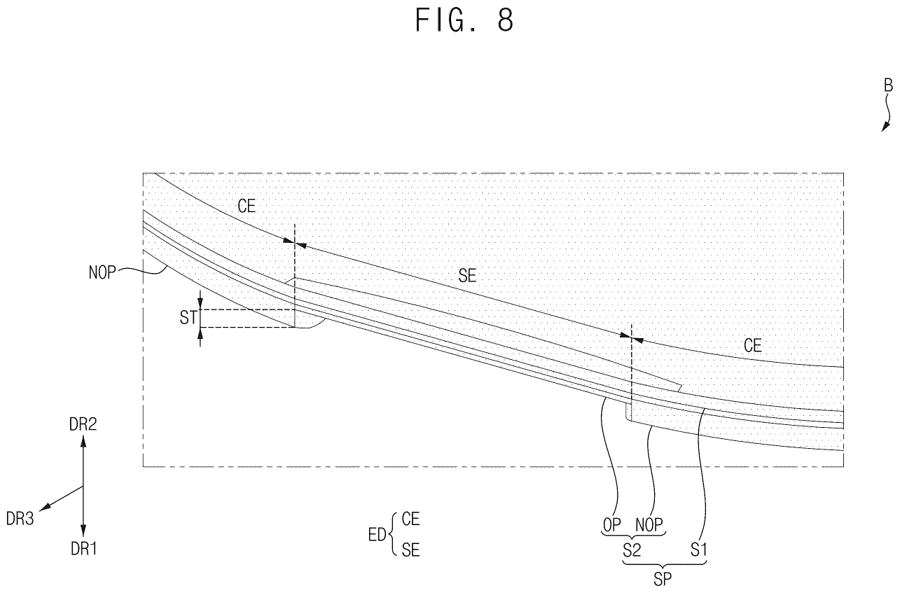

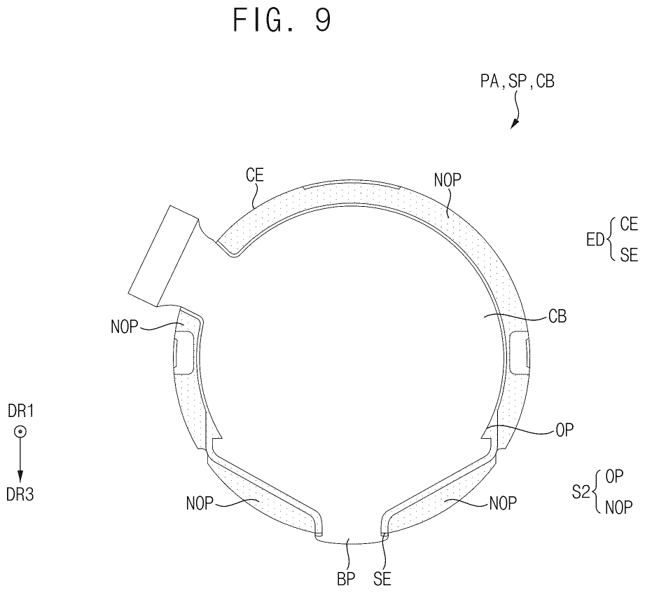

FIG. 5 is a cross-sectional view taken along line I-I′ of FIG. 1. FIG. 6 is an enlarged cross-sectional view of area A of FIG. 5. FIG. 7 is a perspective view illustrating an embodiment of a shape maintaining portion included in the display device of FIG. 1. FIG. 8 is an enlarged perspective view of area B of FIG. 7. FIG. 9 is a bottom view illustrating a state in which a display panel, a shape maintaining portion, and a circuit board included in the display device of FIG. 1 are coupled.

Referring to FIGS. 5, 6, 7, 8, and 9, the shape maintaining portion SP, the cover panel CP, the display panel PA, the adhesive layer AL, and the window WN may be disposed on the circuit board CB. In addition, the circuit board CB, the shape maintaining portion SP, the cover panel CP, the display panel PA, and the adhesive layer AL may be accommodated in the window WN.

The shape maintaining portion SP may include a first surface S1 adjacent to the display portion DP of the display panel PA and a second surface S2 adjacent to the circuit board CB. In an embodiment, the first surface S1 may be an upper surface of the shape maintaining portion SP, and the second surface S2 may be a lower surface of the shape maintaining portion SP, for example.

The first surface S1 may include a central portion CS and an edge portion ES. The edge portion ES may surround the central portion CS in a plan view. In an embodiment, the central portion CS may have a shape convexly curved in the second direction DR2 in a cross-sectional view. The edge portion ES may have a flat shape in a cross-sectional view. In an embodiment, the edge portion ES may extend in the third direction DR3, for example. As the central portion CS is convexly curved and the edge portion ES is flat, the shape maintaining portion SP may be easily manufactured (refer to FIGS. 5 and 6).

The second surface S2 may include an overlapping portion OP and a non-overlapping portion NOP. The overlapping portion OP may overlap the circuit board CB in a plan view. The non-overlapping portion NOP may not overlap the circuit board CB in a plan view. Each of the overlapping portion OP and the non-overlapping portion NOP may be flat. The overlapping portion OP and the non-overlapping portion NOP may have a step ST in a cross-sectional view. In an embodiment, the non-overlapping portion NOP may protrude further in the first direction DR1 than the overlapping portion OP. The overlapping portion OP may be recessed in the second direction DR2 than the non-overlapping portion NOP (refer to FIG. 8).

In an embodiment, when the shape maintaining portion SP and the circuit board CB are coupled to each other, the circuit board CB may be disposed on the overlapping portion OP. In this case, the non-overlapping portion NOP may surround a side surface of the circuit board CB. Accordingly, the circuit board CB may be flat on the second surface S2 of the shape maintaining portion SP. The shape maintaining portion SP may maintain a shape of the circuit board CB (refer to FIG. 9).

An edge ED of the shape maintaining portion SP may include a curved portion CE and a straight portion SE. The curved portion CE may extend while having a curvature. In an embodiment, the curved portion CE may extend in a circular shape having a constant curvature in a plan view, for example. The straight portion SE may extend in a straight line in a plan view. The curved portion CE and the straight portion SE may be extended to each other. Accordingly, in a plan view, the shape maintaining portion SP may have a straight-line shape in a partial area, and may have a circular shape in an area other than the partial area (refer to FIG. 7).

The straight portion SE may correspond to a position where the bending portion BP is bent. The bending portion BP may be bent at the straight portion SE. That is, the bending portion BP may cover the straight portion SE while being bent. The bending portion BP may connect the display portion DP and the circuit board CB with the straight portion SE interposed therebetween. In an embodiment, the edge ED of the shape maintaining portion SP disposed between the display portion DP and the circuit board CB may include the straight portion SE without having a curvature as a whole. Accordingly, the shape maintaining portion SP may not apply an impact to the bending portion BP, and may not interfere with the bending of the bending portion BP (refer to FIGS. 6 and 9).

The circuit board CB may be disposed below the shape maintaining portion SP, and the display portion DP of the display panel PA may be disposed on the shape maintaining portion SP. The circuit board CB may be spaced apart from the display portion DP in the first direction DR1, and the circuit board CB and the bending portion BP of the display panel PA may be connected to each other with the shape maintaining portion SP interposed therebetween.

In an embodiment, the shape maintaining portion SP may include plastic, for example. In this case, the shape maintaining portion SP may be manufactured through an injection molding process, for example. In another embodiment, the shape maintaining portion SP may include a metal. In this case, the shape maintaining portion SP may be manufactured through a computer numerical control (“CNC”) process or die casting process. For another example, the shape maintaining portion SP may include rubber or silicone. In this case, the shape maintaining portion SP may be manufactured through a compression molding process. However, the disclosure is not limited thereto, and the shape maintaining portion SP may include various materials according to a purpose of the shape maintaining portion SP or the like, and may be manufactured through various processes.

In an embodiment, the display portion DP may be disposed along a profile of the first surface S1 of the shape maintaining portion SP, and the circuit board CB may be disposed along a profile of the second surface S2 of the shape maintaining portion SP. Specifically, the display portion DP may be disposed along a profile of the central portion CS of the first surface S1, and the circuit board CB may be disposed along a profile of the overlapping portion OP of the second surface S2. That is, the display portion DP may be convexly curved in the second direction DR2, and the circuit board CB may be flat.

When the circuit board CB is curved, problems such as damage, separation, attachment errors, or the like may occur in the elements disposed on the circuit board CB. In this case, since the shape maintaining portion SP may maintain the flat shape of the circuit board CB, the circuit board CB may be attached to the shape maintaining portion SP while having durability. Accordingly, risk of problems occurring due to curve of the circuit board CB may be reduced. In addition, the shape maintaining portion SP may serve as an assembly guide for the circuit board CB.

The cover panel CP may also be disposed along the profile of the first surface S1 of the shape maintaining portion SP, and the adhesive layer AL may be disposed along a profile of the display portion DP. Specifically, each of the central portion CS of the first surface S1 of the shape maintaining portion SP, the cover panel CP, the display portion DP, and the adhesive layer AL may have a cross-sectional shape convexly curved in the second direction DR2 so that a distance from the circuit board CB to a portion of each of the central portion CS of the first surface S1 of the shape maintaining portion SP, the cover panel CP, the display portion DP, and the adhesive layer AL along the first direction DR1 or the second direction DR2 increases from an edge of the display device DD to a center of the display device DD in a planar direction (e.g., the third direction DR3). The display portion DP of the display panel PA may be coupled to a curved inner surface of the window WN by the adhesive layer AL.

The display device DD in an embodiment of the disclosure may include the shape maintaining portion SP including the first surface S1 and the second surface S2 having different cross-sectional shapes. The first surface S1 may include the central portion CS convexly curved in the second direction DR2, and the second surface S2 may include the flat overlapping portion OP on which the circuit board CB is disposed. Accordingly, the display panel PA may be disposed to correspond to the shape of the window WN, and since the circuit board CB may maintain the shape, damage to the elements disposed on the circuit board CB may be prevented.

In addition, since the shape maintaining portion SP includes the straight portion SE extending in a straight line, interference of the shape maintaining portion SP with respect to the bending of the display panel PA may be prevented. In addition, since the first surface S1 of the shape maintaining portion SP includes the flat edge portion ES, the shape maintaining portion SP may be easily manufactured.

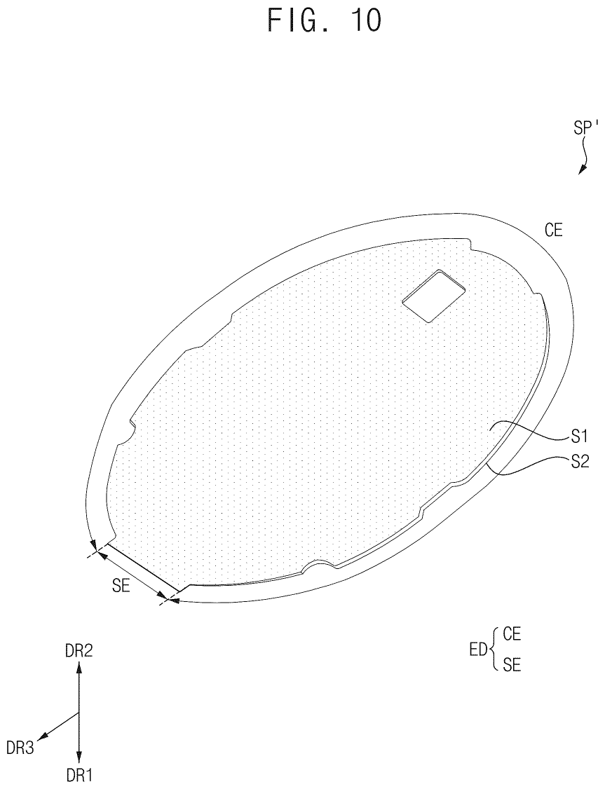

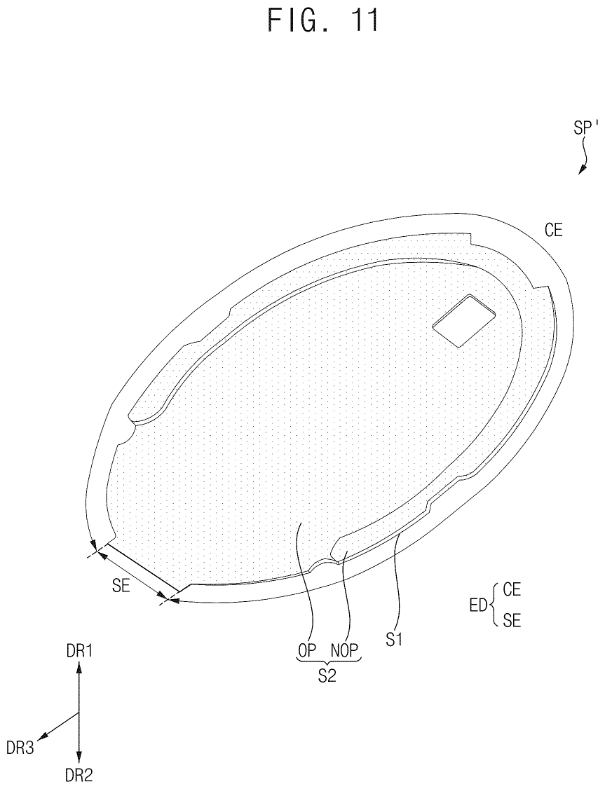

FIGS. 10 and 11 are perspective views illustrating another embodiment of a shape maintaining portion included in the display device of FIG. 1. In an embodiment, FIG. 10 may be a perspective view illustrating a planar shape of a first surface S1 of a shape maintaining portion SP′, and FIG. 11 may be a perspective view illustrating a planar shape of a second surface S2 of the shape maintaining portion SP′, for example.

The shape maintaining portion SP′ described with reference to FIGS. 10 and 11 may be substantially the same as or similar to the shape maintaining portion SP described with reference to FIGS. 7, 8, and 9 except for a shape of the second surface S2.

Hereinafter, descriptions overlapping the shape maintaining portion SP described with reference to FIGS. 7, 8, and 9 will be omitted or simplified.

Referring to FIGS. 10 and 11, an edge ED of the shape maintaining portion SP′ may include a curved portion CE and a straight portion SE. The curved portion CE may extend in a circular shape in a plan view. The straight portion SE may be extended to the curved portion CE and extend in a straight line in a plan view.

The shape maintaining portion SP′ may include the first surface S1 adjacent to a display portion (e.g., the display portion DP of FIG. 5) and the second surface S2 adjacent to a circuit board (e.g., the circuit board CB of FIG. 5). In an embodiment, the first surface S1 may be an upper surface of the shape maintaining portion SP′, and the second surface S2 may be a lower surface of the shape maintaining portion SP′, for example.

The second surface S2 may include an overlapping portion OP and a non-overlapping portion NOP. The overlapping portion OP may overlap the circuit board in a plan view, and the non-overlapping portion NOP may not overlap the circuit board in a plan view. In an embodiment, the non-overlapping portion NOP may protrude further in a first direction DR1 than the overlapping portion OP.

The circuit board may be disposed on the overlapping portion OP. In an embodiment, the non-overlapping portion NOP may surround at least a portion of a side surface of the circuit board. Specifically, the non-overlapping portion NOP may surround a portion of the side surface of the circuit board, and may not surround another portion of the side surface of the circuit board. In an embodiment, the non-overlapping portion NOP may not surround the side surface of the circuit board CB adjacent to the straight portion SE, for example. Accordingly, on the second surface S2, the overlapping portion OP may include an area adjacent to the straight portion SE.

That is, a planar area of the overlapping portion OP of the shape maintaining portion SP′ may be relatively larger than a planar area of the overlapping portion OP of the shape maintaining portion SP described with reference to FIGS. 7, 8, and 9, and a planar area of the non-overlapping portion NOP of the shape maintaining portion SP′ may be relatively smaller than a planar area of the non-overlapping portion NOP of the shape maintaining portion SP described with reference to FIGS. 7, 8, and 9. However, the disclosure is not limited thereto, and the shape and area of each of the overlapping portion OP and the non-overlapping portion NOP may be variously changed.

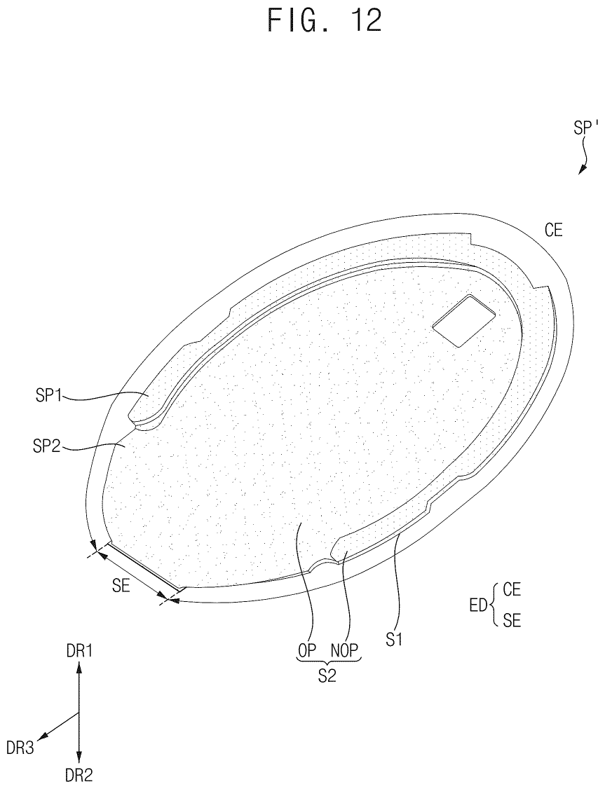

FIG. 12 is a perspective view illustrating another embodiment of FIG. 11. In an embodiment, FIG. 12 may be a perspective view illustrating another embodiment of a planar shape of the second surface S2 of the shape maintaining portion SP′, for example.

Hereinafter, descriptions overlapping the shape maintaining portion SP′ described with reference to FIGS. 10 and 11 will be omitted or simplified.

Referring to FIG. 12, the second surface S2 of the shape maintaining portion SP′ may include the overlapping portion OP and the non-overlapping portion NOP.

In an embodiment, the shape maintaining portion SP′ may include a first shape maintaining portion SP1 and a second shape maintaining portion SP2. The first shape maintaining portion SP1 and the second shape maintaining portion SP2 may include different materials from each other. In an embodiment, the first shape maintaining portion SP1 may include plastic, and the second shape maintaining portion SP2 may include copper (Cu), for example, but the disclosure is not limited thereto. In addition, in this case, the shape maintaining portion SP′ may be manufactured through an insert molding process, but the disclosure is not limited thereto.

The second shape maintaining portion SP2 may be disposed on the first shape maintaining portion SP1. Specifically, the second shape maintaining portion SP2 may be adjacent to the first shape maintaining portion SP1 in the first direction DR1. In the shape maintaining portion SP′, the first shape maintaining portion SP1 may define the non-overlapping portion NOP, and the second shape maintaining portion SP2 may define the overlapping portion OP.

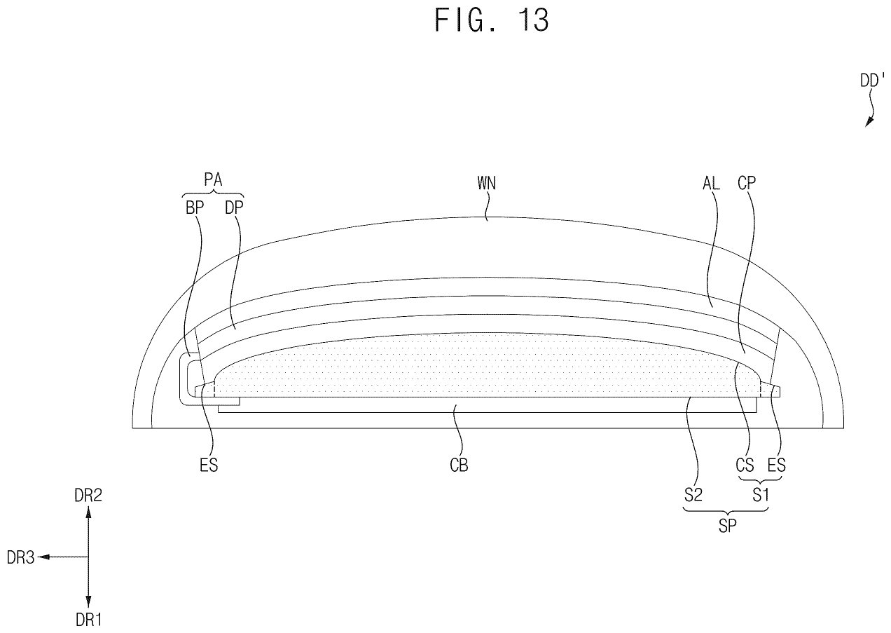

FIG. 13 is a cross-sectional view illustrating another embodiment of a display device according to the disclosure. In an embodiment, FIG. 13 may correspond to the cross-sectional view of FIG. 5, for example.

A display device DD′ described with reference to FIG. 13 may be substantially the same as or similar to the display device DD described with reference to FIGS. 1, 2, 3, 4, 5, 6, 7, 8, and 9, except for shapes of a shape maintaining portion SP, a cover panel CP, a display panel PA, and an adhesive layer AL.

Hereinafter, descriptions overlapping the display device DD described with reference to FIGS. 1 to 9 will be omitted or simplified.

Referring to FIG. 13, the display device DD′ may include a window WN, the adhesive layer AL, the display panel PA, the cover panel CP, the shape maintaining portion SP, and a circuit board CB.

The shape maintaining portion SP, the cover panel CP, the display panel PA, the adhesive layer AL, and the window WN may be sequentially disposed on the circuit board CB. The display panel PA may include a display portion DP that displays an image and a bending portion BP connected to the circuit board CB.

The shape maintaining portion SP may include a first surface S1 adjacent to the display portion DP of the display panel PA and a second surface S2 adjacent to the circuit board CB. In an embodiment, the first surface S1 may be an upper surface of the shape maintaining portion SP, and the second surface S2 may be a lower surface of the shape maintaining portion SP, for example.

The first surface S1 may include a central portion CS and an edge portion ES surrounding the central portion CS. The central portion CS may have a shape convexly curved in a second direction DR2 in a cross-sectional view, and the edge portion ES may have a flat shape in a cross-sectional view. In an embodiment, the edge portion ES may have an inclination.

The cover panel CP and the display portion DP of the display panel PA may be disposed along a profile of the first surface S1 of the shape maintaining portion SP. The adhesive layer AL may be disposed along a profile of the display portion DP. Specifically, each of the cover panel CP, the display portion DP, and the adhesive layer AL may have a cross-sectional shape having an inclination at an edge and convexly curved in the second direction DR2 to be away from the circuit board CB as it goes from the edge to a center. As the display portion DP has the inclination at the edge, an image may also be displayed on a side surface of the display device DD′.

The disclosure may be applied to various display devices. In embodiments, the disclosure is applicable to various display devices such as display devices for vehicles, ships and aircraft, portable communication devices, display devices for exhibition or information transmission, medical display devices, or the like, for example.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. Therefore, it is to be understood that the foregoing is illustrative of various embodiments and is not to be construed as limited to the illustrative embodiments disclosed, and that modifications to the disclosed embodiments, as well as other embodiments, are intended to be included within the scope of the appended claims.

What is claimed is:

1. A display device comprising:
a display panel including:
a display portion; and
a bending portion adjacent to the display portion;
a circuit board spaced apart from the display portion in a first direction and connected to the bending portion; and
a shape maintaining portion disposed between the display portion and the circuit board and including:
a first surface adjacent to the display portion, and the first surface including:
a central portion convexly curved in a second direction opposite to the first direction; and
an edge portion which is flat; and
a second surface adjacent to the circuit board.

2. The display device of claim 1, wherein the second surface includes:
an overlapping portion which overlaps the circuit board in a plan view; and
a non-overlapping portion which does not overlap the circuit board in the plan view, and
the overlapping portion and the non-overlapping portion have a step.

3. The display device of claim 2, wherein the non-overlapping portion protrudes further in the first direction than the overlapping portion.

4. The display device of claim 2, wherein the overlapping portion is flat.

5. The display device of claim 1, wherein an edge of the shape maintaining portion includes:
a curved portion extending in a circular shape in a plan view; and
a straight portion extended to the curved portion and extending in a straight line in the plan view.

6. The display device of claim 5, wherein the bending portion covers the straight portion.

7. The display device of claim 1, wherein the display portion is disposed along a profile of the first surface of the shape maintaining portion, and
the circuit board is disposed along a profile of the second surface of the shape maintaining portion.

8. The display device of claim 1, further comprising:
a window disposed on the display panel,
wherein the window has a dome shape which is convexly curved in the second direction.

9. The display device of claim 8, wherein the window accommodates the display panel, the circuit board, and the shape maintaining portion.

10. The display device of claim 1, wherein the edge portion has an inclination.

11. A display device comprising:
a display panel including:
a display portion; and
a bending portion adjacent to the display portion;
a circuit board spaced apart from the display portion in a first direction and connected to the bending portion; and
a shape maintaining portion disposed between the display portion and the circuit board, the shape maintaining portion including:
a first surface adjacent to the display portion;
a second surface adjacent to the circuit board; and
an edge including:
a curved portion extending in a circular shape in a plan view; and
a straight portion extended to the curved portion and extending in a straight line in the plan view.

12. The display device of claim 11, wherein the bending portion covers the straight portion.

13. The display device of claim 11, wherein a central portion of the first surface is convexly curved in a second direction opposite to the first direction, and
an edge portion of the first surface is flat.

14. The display device of claim 11, wherein the second surface includes:
an overlapping portion which overlaps the circuit board in the plan view; and
a non-overlapping portion which does not overlap the circuit board in the plan view, and
the overlapping portion and the non-overlapping portion have a step.

15. The display device of claim 14, wherein the non-overlapping portion protrudes further in the first direction than the overlapping portion.

16. The display device of claim 14, wherein the overlapping portion is flat.

17. The display device of claim 11, wherein the display portion is disposed along a profile of the first surface of the shape maintaining portion, and
the circuit board is disposed along a profile of the second surface of the shape maintaining portion.

18. The display device of claim 11, further comprising:
a window disposed on the display panel,
wherein the window has a dome shape which is convexly curved in a second direction opposite to the first direction.

19. The display device of claim 18, wherein the window accommodates the display panel, the circuit board, and the shape maintaining portion.

20. The display device of claim 13, wherein the edge portion has an inclination.
